(19) United States
(12) Patent Application Publication
(10) Pub. No.: US 2021/0311957 A1
(43) Pub. Date: Oct. 7, 2021

(54) CROSS-CLOUD AUTO INGEST

(71) Applicant: Snowflake Inc., San Mateo, CA (US)

(72) Inventors: Gjorgji Georgievski, Kirkland, WA (US); Ganeshan Ramachandran Iyer, Redmond, WA (US); Dinesh Chandrakant Kulkarni, Sammamish, WA (US); Jiaxing Liang, Bellevue, WA (US); Subramanian Muralidhar, Mercer Island, WA (US)

(21) Appl. No.: 16/842,243

(22) Filed: Apr. 7, 2020

(51) Int. Cl. G06F 16/25; G06F 9/54; G06F 9/46; H04L 29/08

(52) U.S. Cl. CPC G06F 16/254; H04L 67/1097; G06F 9/466; G06F 9/542

(57) ABSTRACT

Embodiments of the present disclosure may provide cross cloud auto-ingestion techniques. A deployment may monitor multiple queues across different cloud providers and may classify the queues based on their cloud. provider type. The deployment may receive notifications from those queues regarding new data ready for ingestion. The deployment may maintain a pool of credentials and may assign appropriate credentials to each queue. The deployment may route the notifications to appropriate receivers based on cloud provider types. The receivers may then auto-ingest new data in the corresponding queue.

### TECHNICAL FIELD

The present disclosure generally relates to data systems, such as databases, and, more specifically, to automatic ingestion of data across data systems in different cloud providers.

### BACKGROUND

Data systems, such as database systems, may be provided through a cloud platform, which allows organizations and users to store, manage, and retrieve data from the cloud. A variety of techniques can be employed for uploading and storing data in a database or table in a cloud platform. Those techniques are typically limited to situations where a source and a target table are provided in the same cloud provider.

To upload data from a different cloud source, conventional systems typically require a user to copy new data using a “copy” command, which also necessitates the use of a running warehouse for transferring the data to the target table. This conventional approach suffers from at least two significant drawbacks, however. First, the “copy” command must be manually initiated by a user. This manual initiation can cause latency issues with respect to how fresh the data is in the target table, depending on how often the “copy” command is initiated. This manual initiation can also cause some or all the data to be lost if the “copy” task fails. Second, operating a running warehouse for the “copy” command typically incurs large expenses.

### BRIEF DESCRIPTION OF THE DRAWINGS

Various ones of the appended drawings merely illustrate example embodiments of the present disclosure and should not be considered as limiting its scope.

FIG. 1 is a block diagram of a system for automated data ingestion, according to some example embodiments.

FIG. 2 shows a flow diagram for configuring an integration, according to some example embodiments.

FIG. 3 shows a flow diagram for cross-cloud batch data ingestion, according to some example embodiments.

FIG. 4 is a block diagram of a system for automated. data ingestion, according to some example embodiments.

FIG. 5 is a block diagram of a process of ingesting data, according to some example embodiments.

FIG. 6 is a block diagram of components of a retrieval and data storage system, according to some example embodiments.

FIG. 7 is a block diagram of a resource manager, according to some example embodiments.

FIG. 8 is a block diagram of an execution platform, according to some example embodiments.

FIG. 9 is a block diagram of components of an operating environment, according to some example embodiments.

FIG. 10 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Embodiments of the present disclosure may provide cross cloud auto-ingestion techniques. A deployment may monitor multiple queues across different cloud providers and may classify the queues based on their cloud provider type. The deployment may receive notifications from those queues regarding new data ready for ingestion. The deployment may maintain a pool of credentials and. may assign appropriate credentials for each queue. The deployment may monitor notifications from queues and may route the notifications to appropriate receivers based on cloud provider types. The receivers may then auto-ingest new data from the corresponding queue and store the data in a source table. Therefore, embodiments of the present disclosure provide efficient and cost-reducing techniques for automatically uploading data across different cloud providers.

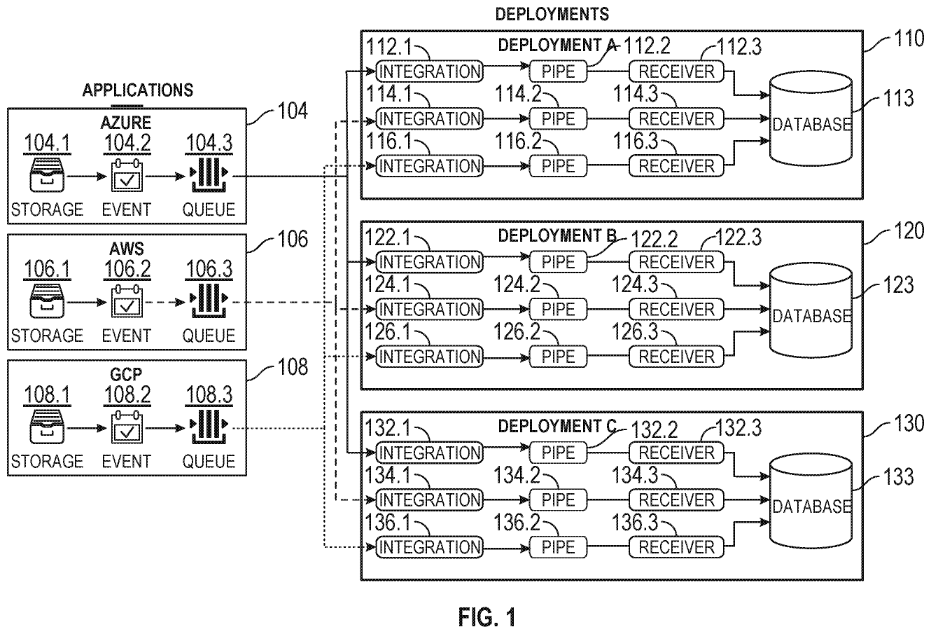

FIG. 1 is a block diagram architecture model of a system 100 for cross-cloud automated data ingestion, in accordance with some embodiments of the present disclosure. The system 100 may include user applications 104, 106, 108, which are applications on different cloud provider platforms, a deployment A 110, a deployment B 120, and a deployment C 130. For example, application 104 may be provided on a first cloud provider type (e.g., Azure), application 106 may be provided on a second cloud provider type (e.g., Amazon Web Services), and application 108 may be provided on a third cloud provider type (e.g., Google Cloud Platform).

Each of the applications 104, 106, 108 may include one or more data buckets or data lakes comprising user files. Each of the client accounts is coupled to a client account queue comprising a listing of user files to be ingested into a database. As illustrated in FIG. 1, application 104 may include a storage 104.1, an event block 104.2, and a queue 104.3. Application 106 may include a storage 106.1, an event block 106.2, and a queue 106.3. And application 108 may include a storage 108.1, an event block 108.2, and a queue 108.3. In an embodiment, a plurality of client accounts may feed into one or more client account queues.

Deployment A 110 may be implemented at least in part on a cloud. In this example, deployment A 110 may be provided on the same cloud. provider type as one of the user applications (for example, application 106) but different from the cloud. provider types of the other applications. In some embodiments, deployment A 110 may be provided on a different cloud provider type than all coupled user applications.

For each coupled queue, a deployment may include an integrator, a pipe, and a receiver, which in turn is coupled to a shared database or data system. For example, Deployment A 110 may include an integration 112.1, which is coupled to queue 104.3; a pipe 112.2; and a receiver 112.3. Deployment A 110 may also include an integration 114.1, which is coupled to queue 106.3; a pipe 114.2; and a receiver 114.3. Deployment A 110 may further include an integration 116.1, which is coupled to queue 108.3; a pipe 116.2; and a receiver 116.3. The receivers 112.3, 114.3, 116.3 may be coupled to a database 113. In an embodiment, the receivers 112.3, 114.3, 116.3 may be coupled. to one or more different databases; for example, receiver 112.3 may be coupled to a first database, receiver 114.3 may be coupled to a second database, and receiver 116.3 may be coupled to a third database.

Likewise, Deployment B 120 may include an integration 122.1, which is coupled to queue 104.3; a pipe 122.2; and a receiver 122.3. Deployment B 120 may also include an integration 124.1, which is coupled to queue 106.3; a pipe 124.2; and a receiver 124.3. Deployment B 120 may further include an integration 126.1, which is coupled to queue 108.3; a pipe 126.2; and a receiver 126.1. The receivers 122.3, 124.3, 126.3 may be coupled to a database 123. In an embodiment, the receivers 122.3, 124.3, 126.3 may be coupled to one or more different databases; for example, receiver 122.3 may be coupled to a first database, receiver 124.3 may be coupled to a second database, and receiver 126.3 may be coupled to a third database.

Deployment C 130 may include an integration 132.1, which is coupled to queue 104.3; a pipe 132.2; and a receiver 132.3. Deployment C 130 may also include an integration 134.1, which is coupled to queue 106.3; a pipe 134.2; and a receiver 134.3. Deployment C 130 may further include an integration 136.1, which is coupled to queue 108.3; a pipe 126.2; and a receiver 136.1. The receivers 132.3, 134.3, 136.3 may be coupled to a database 133. In an embodiment, the receivers 132.3, 134.3, 136.3 may be coupled to one or more different databases; for example, receiver 132.3 may be coupled to a first database, receiver 134.3 may be coupled to a second database, and receiver 136.3 may be coupled to a third database.

In an embodiment, deployments B and C may be provided on the same cloud. provider type as deployment A. In an embodiment, deployments B and C may be provided on the same cloud provider type as deployment A but in different regions. In an embodiment, deployments A-C may be provided on different cloud provider types.

Deployments A-C may be configured. to perform automated data ingestion from any of queues 104.3, 106.3, 108.3, even though the queues may be provided on a different cloud provider type than the respective deployment.

Operation of deployment A 110, for example, will be discussed now. In deployment A 110, integration 112.1 may be configured to receive a notification when new data becomes available in queue 104.3. For example, the queue may include a pool of Simple Queue Service™ (SQS) queues as part of an Amazon Web Services™ S3 bucket. The pool of SQS queues may be provided to client accounts to add user files to a bucket. A notification may be automatically generated when one or more user files are added to a client account data bucket. A plurality of customer data buckets may be provided for each client account. The automatically generated notification may be received by the integration 112.1.

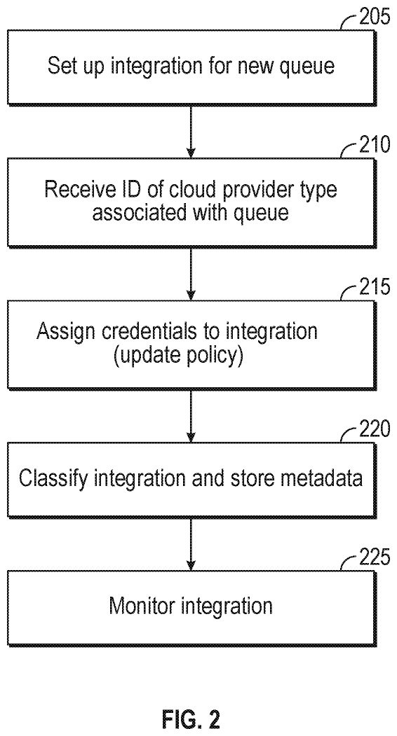

For example, the integration 112.1 may provide information relating to an occurrence of an event in the queue 104.3. Events may include creation of new data, update of old data, and deletion of old data. The integration 112.1 may also provide identification information for a resource associated with the event, e.g., the user file that has been created, updated, or deleted. The integration 112.1 may communicate with the queue 104.3 because the integration 112.1 may be provided with credentials for the queue 104.3, for example by an administrator and/or user. In an embodiment, the integration 112.1 may poll the queue 104.3 for notifications. Configuration procedures for integrations are described below with reference to FIG. 2.

The integration 112.1 may deliver the notification to the pipe 114.2, which may be provided as a single pipe or multiple pipes. The pipe 112.2 may store information relating to what data and the location of the data for automatic data ingestion related to the queue 104.3.

The receiver 114.3 may perform the automated data ingestion, and then store the ingested data in the database 113. Data ingestion may be performed using the techniques described in U.S. patent application Ser. No. 16/201,854, entitled “Batch Data Ingestion in Database Systems,” filed on Nov. 27, 2018, which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

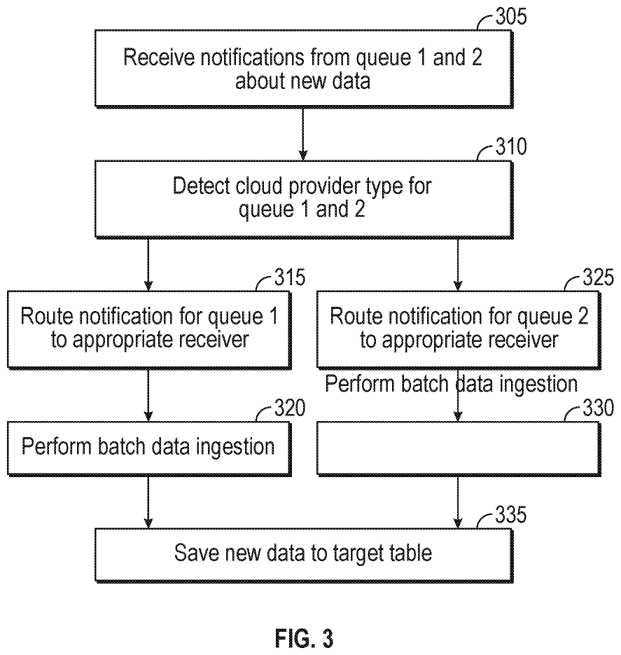

Integration 112.1, pipe 112.2, and receiver 112.3 may be classified based on the cloud provider type of the coupled queue 104.3, and this classification may be stored in a metadata store. Similarly, integration 114.1, pipe 114.2, and receiver 114.3 may be classified based on the cloud provider type of the coupled queue 106.3 and this classification may be stored in the metadata store; and integration 116.1, pipe 116.2, and receiver 116.3 may be classified based on the cloud provider type of the coupled queue 108.3 and this classification may be stored in the metadata store. As explained in further detail below with reference to FIG. 3, this classification may then be used to track different queues and route notifications from the queues to the appropriate components based on the detected cloud provider type to enable automated data ingestion across different cloud provider types.

In an embodiment, the queues may be message queuing service that decouples and scales microservices, distributed systems, and serverless applications. In an embodiment, the queues may be an Amazon. Simple Queue Service (SQS) provided by Amazon Web Services. The SQS enables building applications from individual components that each perform a discrete function for improving scalability and reliability. SQS can improve the cost-effectiveness of decoupling and coordinating components of a cloud application. With SQS, a client may send, store, and receive messages between software components at any volume, without losing messages or requiring other services to be always available.

In an embodiment, SQS may provide two types of message queues, including a standard queue and a FIFO queue. The standard queue offers maximum throughput, best-effort ordering, and at-least-once-delivery of message. FIFO (First In First Out) queues are designed to guarantee that messages are processed exactly once, in the exact order that they are sent, with limited throughput.

FIG. 2 shows a flow diagram of method 200 for configuring an integration, according to some example embodiments. The method 200 may be executed by a deployment, for example a resource manager as disclosed herein. At operation 205, a request by a user or client may be received to set up of an integration of a new queue that the user or client would like the deployment to be able to automatically retrieve new data from, i.e., automatic ingestion. At operation 210, a cloud provider type associated with the new queue may be received or detected. The cloud provider type associated with the queue may be different from the cloud provider type of the deployment. Also, a location of the queue may be received. The location may be cloud-provider specific. For example, for a queue associated with Azure, the location may be a queue URL; for a queue associated with Amazon, the location may be an address for the queue; for a queue associated with Google Cloud Platform, the location may be a subscription name.

At operation 215, credentials may be assigned to the integration based on the cloud type associated with the queue. The credentials may be assigned from a pool of credentials assigned by the deployment. The credentials may be used for authentication. Policy changes for the assigned credentials may be received and stored, for example to give authorization to read from the queue.

At operation 220, the integration and its cloud-provider type may be classified, and that data may be stored. in a metadata store. The metadata store may then track the integration along with other integrations in the deployment. The other integrations may be associated with other cloud-provider types.

At operation 225, different notification channels associated with the different queues (and integrations) may be monitored. The channels may be the link between an integration and queue. The different channels may be associated with different cloud provider types.

FIG. 3 shows a flow diagram of method 300 for cross-cloud batch data ingestion, according to some example embodiments. The method 200 may be executed by a deployment, for example a resource manager and/or execution platform as disclosed herein. At operation 305, notifications from multiple queues (for example, queue 1 and queue 2) may be received. Both notifications are discussed here together for illustration purposes only; the notifications may be received at different times and more than two notifications may be received. The notifications may indicate that the associated queues have new data ready for ingestion. As described above, the notifications may be received when the deployment is monitoring different channels by, for example, an IngestNotificationChannelDPO, which stores channel type information.

At step 310, the cloud provider type for each notification may be detected. In this example, the cloud provider types for queues 1 and 2 may be detected. The cloud provider type may be detected based on the stored classification for those queues in the metadata store (e.g., IngestNotificationChannelDPO). Next, based on the detected cloud provider types, each notification may be routed to appropriate components for processing. For example, at operation 315, based. on the detected cloud provider type for queue 1, the notification may be routed to an appropriate pipe and receiver, which may be configured to handle communication with the detected cloud provider type of queue 1. At operation 320, the receiver may then perform batch data ingestion of the new data in queue 1 using assigned credentials. At operation 335, the ingested new data from queue 1 may be saved in a target table in a database or data system.

Similarly, at operation 325, based on the detected cloud provider type for queue 2, the notification may be routed to an appropriate pipe and receiver, which may be configured to handle communication with the detected cloud provider type of queue 2. At operation 330, the receiver may then perform batch data ingestion of the new data in queue 2 using assigned credentials. At operation 335, the ingested new data from queue 2 may be saved in the target table in the database or data system.

After ingested data is saved in the target table and is committed to the target table, metadata concerning; the target table may be registered in a metadata store. Consequently, the deployment may be able to perform batch data ingestion from different applications (and queues) in different cloud provider types in an efficient and cost-reducing manner.

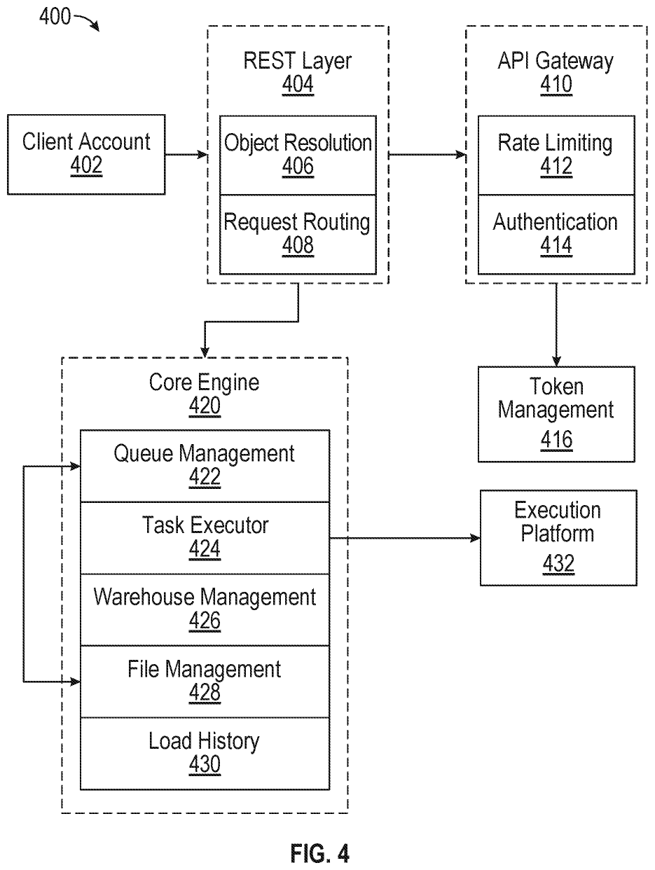

FIG. 4 is a schematic block diagram of a system 400 for batch data ingestion and for storing database data in one or more tables by way of a data pipeline system, according to some example embodiments. The system 400 includes a client account 402 that may be in communication with a database system. The client account 402 may provide new data or update data to be committed to a database, for example by way of a queue. The client account 402 may be provided. on the same or different cloud provider type as the database system. The system 400 includes REST (Representational State Transfer) layer 404 that includes object resolution 406 and request routing 408 systems. The system 400 includes an API (Application Program Interface) gateway 410 that includes rate limiting 412 and authentication 414 systems. The system 400 includes token management 416 protocol. The system includes a core engine 420 in communication with the REST layer 404. The core engine 420 includes systems or protocols responsible for queue management 422, task execution 424, warehouse management 426, file management 428, and load history 430. The core engine 420 is in communication with an execution platform 432 that is configured to execute one or more tasks, such as data ingestion tasks.

The client account 402 is in communication, either directly or indirectly, with a resource manager (see e.g. 504, 602) of a database system. The REST layer 404 may be a component of the resource manager. The client account 402 provides user files to be ingested. into a database. The user files may be uploaded to a vendor service, such as Amazon Web Services™ or other suitable cloud computing service. As discussed above, the client account 402 may be on a different cloud computing service as the database system. The resource manager may receive a notification that a user file has been added to the client account that should be ingested into the database, or that some data within the database should be updated. In various implementations, the resource manager may receive such notification automatically or it may periodically poll a data bucket associated with the client account 402 to determine whether any user files have been added.

The REST layer 404 includes a thin outer layer capable of handling payload translation into internal format and is further capable of handling simple validation. In an embodiment, the REST layer 404 exists inside a resource manager (see e.g. 504, 602). The REST layer 404 includes object resolution 406 responsible for transitioning from a scoped table name to a table identification (may be referred to herein as TableID). The REST layer 404 further includes request routing 408 responsible, based at least in part on a detected cloud provider type associated with the client account 402, for routing a request to the proper instance of a resource manager for a destination table of a user file received from the client account 402. In an embodiment, request routing 408 occurs after object resolution 406. Request routing 408 may use consistent hashing with virtual nodes to manage which GS instance owns which table.

In an embodiment, when a vendor account (such as a third-party account responsible for receiving user files) receives one or more names of user files, the object resolution 406 protocol. resolves those names of the user files to internal names. The internal names for the user files are cached.

In an embodiment, the request routing 408 protocol of the REST layer 404 of the resource manager is configured to receive user files from the client account 402 and route those user files to one or more execution nodes of an execution platform for ingesting and processing, based at least in part on the cloud provider type of the client account 402. In an embodiment, the vendor account (that is, a third-party account responsible for receiving user files directly or indirectly from a client account 402 and providing those user files to, for example, the resource manager may use consistent hashing with virtual nodes to manage which resource manager owns a particular database table. The vendor account may hash on a table identification and an identification for a particular resource manager to find a match between a user file and a resource manager. The hash space is divided into equally sized partitions. Given a number of resource manager instances, each resource manager takes a number of partitions. When the resource manager adds an execution node to an execution platform (such as the core engine 420), the resource manager will pull random partitions from each execution node to preserve the ratio of partition rations. Similarly, when an execution node fails, the ration of partitions is spread out among remaining execution nodes. This mapping may be maintained by a vendor account.

In an embodiment, a database record including all virtual node mappings is transactionally modified every time a virtual node assignment is changed. A value associated with the virtual node will be stored in memory with an object that is processing requests for a given. table of the database. The value may be passed back and forth with every interaction between the resource manager and an execution platform 432. The value may be used to detect stale state or requests which may be discarded.

In an embodiment, a tableList slice is used during recovery situations to communicate with the vendor account. The tableList slice may indicate what database tables are managed by a given virtual node. The tableList slice may be added to or amended as needed and may be cleaned up on a best effort basis when the vendor account notice for a table has been deleted or is no longer active.

In an embodiment, the entire virtual node table may be cached in memory on each resource manager. Each resource manager may watch for changes to a database table and poll the database table periodically as a backup measure. In an embodiment, when a request to ingest new user files must be routed by the request routing 108 protocol, the vendor account may hash the tableId and determine the virtual node containing the hash, and then the vendor account may look up the virtual node in the table and route to a particular resource manager.

The API gateway 410 includes a thin layer to guard access to the core engine 420. The API gateway 410 includes rate limiting 412 responsible for basic limits to prevent a large influx of data ingestion requests. The API gateway 410 includes authentication 414 responsible for validating the API token passed in a REST request.

In an embodiment, the authentication 414 protocol comprises a set of down-scoped credentials. In an embodiment, the set of down-scoped credentials includes credentials for different cloud provider types associated with client accounts. The down-scoped credentials may be used to create an API token scoped to a particular table. The token may have the TableID baked into it and may be created programmatically. The token may have a short lifetime (in an embodiment the token may expire in 30 minutes, one hour, two hours, three hours, and so forth). In an embodiment a client account 402 may dictate the expiration of the token and/or receive a new token programmatically. In an embodiment, the system 400 receives the token, validates the token, and validates whether the TableID specified in the token matches the name of the table specified in the REST request. In an implementation where the TableID and the table specified in the REST request do not match, the caller will receive a particular error response that will request a new token. In an embodiment, the system 400 requires a new token to every time a table is modified.

Token management 416 is responsible for generating new tokens and revoking prior tokens on demand. The core engine 420 is a core logic that manages the processing of incoming data. The core engine 420 includes queue management 422 responsible for managing queues of incoming files, including adding or removing files from the queue. The task executor 424 begins and manages the execution platform jobs for loading files, including interactions with a compiler. The warehouse management 426 manages a loading warehouse, including scaling up and down on demand.

A cloud data warehouse (also referred to as a “network-based data. warehouse” or simply as a “data warehouse”) is one type of network-based. data system used for data analysis and reporting that comprises a central repository of integrated data from one or more disparate sources. A cloud data warehouse is commonly an online analytical processing (OLAP) database that can store current and historical data that can be used for creating analytical reports for an enterprise, based on data stored within databases of the enterprise. To this end, data warehouses typically provide business intelligence tools, tools to extract, transform, and load data into the repository, and tools to manage and retrieve metadata. There are other types of network-based data systems, such as online transaction processing (OLTP) databases, as well as data systems that operate with characteristics of multiple types of traditional database systems.

The warehouse management 426 also stores data relating to different cloud. provider types. The file management 428 is responsible for handling the ingest version of registering native binary files and capturing errors. The load history 430 tracks the history of the loads and errors for a given table. The load history 430 may further purge load history after a period or after a maximum number of entries has been reached.

In an embodiment, the task executor 424 knows the current total number of active tasks and the desired number of active tasks. The task executor 424 communicates the desired number of active tasks to a resource manager that will strive to keep the size of the warehouse at the desired number of active tasks. The resource manager may accomplish that by smoothing the demand over time by way of a moving average over some time period that is a fraction of the desired latency. The resource manager may further accomplish that by keeping the size of the warehouse slightly larger than the actual need to accommodate temporary spikes. The resource manager may further accomplish that by carefully releasing execution nodes and/or assigning work to one or more execution nodes in such a way as to compact the usage to permit reasonable freeing of execution nodes when needed.

In an embodiment, the task executor 424 generates the execution plan of the ingest task. The execution plan may be similar to the plan of copy command. The task executor 424 may create a code change in copy option including an internal Boolean option “ingest mode” to current copy command. The execution plan may compile from the SQL text “copy into T ingest_mode=true” to disable certain functions. The task executor 124 may further include a code change in scansset, including a Boolean property “dynamic_scanset” that may be true if the copy is in ingest mode.

In an embodiment, warehouse management 426 manages the warehouse for data ingestion. The warehouse management 426 may control scaling up and down based on demand, assign work to execution nodes, track states of tasks on the warehouse to allow correct assignments, and track failed servers and respond accordingly. In an embodiment, the warehouse management 426 is incorporated in a resource manager. It should be noted that because the ingest task is single threaded, there will be assigned one task per core on one warehouse node. For each warehouse node, the number of running tasks is tracked. The task executor 424 may schedule a new task, ask the warehouse management 426 for a server to use, and the warehouse management 426 will choose already busy servers to make it easier to free execution nodes when the load decreases. The task executor 424 may inform warehouse management 428 about task completion.

In an embodiment, load history 430 monitors the loading result and keeps track of whether files or data have successfully been ingested into the database. The ingest history may further be stored in a metadata store within the database or separate from the database and accessible by a resource manager. The ingest history includes, for example, the file name, TableID, file size, row count, status, and first error. In an embodiment, the error management of the data loading will be a separated project.

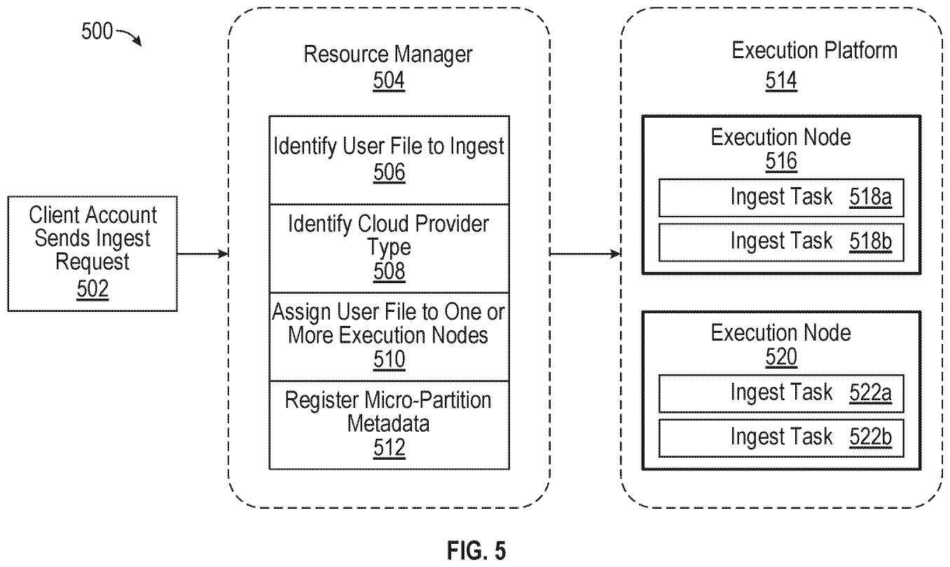

FIG. 5 is a schematic block diagram of a process 500 of ingesting data into a database, according to some example embodiments. The process 500 begins and a client account sends an ingest request at step 502. The client account may directly or indirectly communicate with the database system to send in the ingest request. The client account may be associated with a different cloud provider type than the database system. In an embodiment, the ingest request is a notification provided by a third-party vendor storage account, or the ingest request may arise from a resource manager polling a data lake associated with the client account to determine whether any user files have been added to the client account that have not yet been ingested into the database. The notification includes a list of user files to insert into a table of the database. The user files are persisted in a queue specific to the receiving table of the database.

The ingest request is received by a resource manager 504. The resource manager 504 identifies at step 506 a user file to ingest. At step 508, the resource manager identifies a cloud provider type associated with the client account. At step 510, the resource manager 504 may assign the user file to one or more execution nodes, based at least in part on the detected cloud provider type, and registers at step 512 micro-partition metadata associated with a database table after the user file is ingested into a micro-partition of the database table. The resource manager 504 provisions one or more execution nodes 516, 520 of an execution platform 514 to perform one or more tasks associated with ingesting the user file. Such ingest tasks 518a, 518b, 522a, 522b include, for example, cutting a user file into one or more partitions, generating a new micro-partition based on the user file, and/or inserting the new micro-partition in a table of the database.

The process 500 begins an IngestTask that will run on a warehouse. The IngestTask will pull user files from the queue for a database table until it is told to stop doing so. The IngestTask will periodically cut a new user file and add it to the database table. In one embodiment, the ingest process is “serverless” in that it is an integrated service provided by the database or resource manager 504. That is, a user associated with the client account need not provision its own warehouse or a third-party warehouse in order to perform the ingestion process. For example, the database or database provided (e.g., via instances of the resource manager 504) may maintain the ingest warehouse that then services one or more or all accounts/customers of the database provider.

It should be appreciated that there may be more than one IngestTask pulling from a queue for a given table, and this might be necessary to keep up with the rate of incoming data. In an embodiment, the IngestTask may decide the time to cut a new file to increase the chances of getting an ideal sized file and avoid “odd sized” files that would result if the file size was line up with one or more user files. This may come at the cost of added complexity as the track line number of the files consumed must be tracked.

In an embodiment, all requests for a particular table will be routed to a single instance of the resource manager 504. Each instance of the resource manager 504 may be responsible for a set of database tables. In an embodiment, this is accomplished by using consistent hashing with virtual nodes that permits a node to be treated as a write-through cache for the queue, eliminating the need to read the items in the queue from the metadata store.

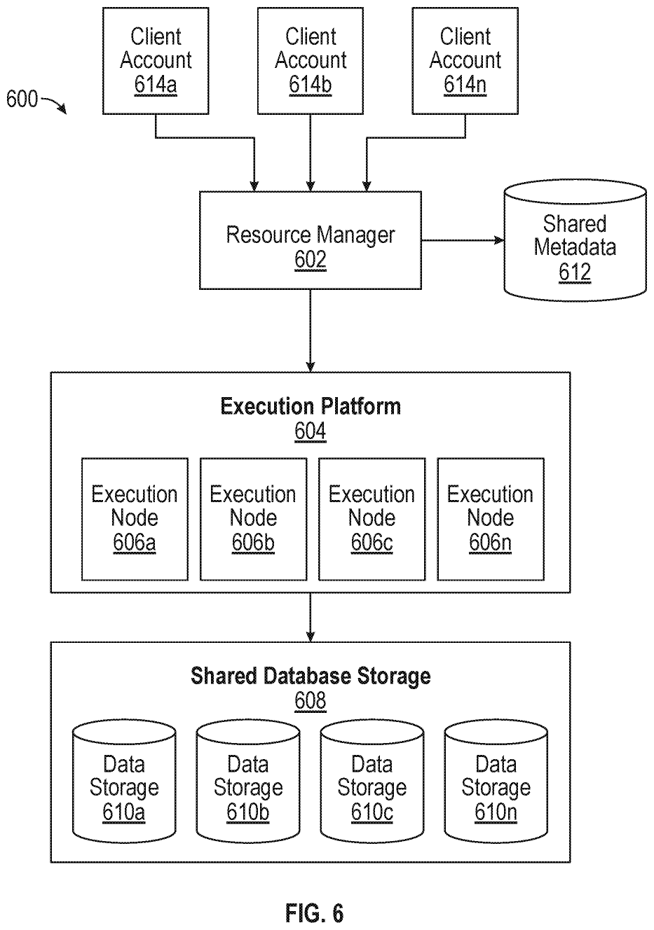

FIG. 6 illustrates a data processing platform 600 for running the methods disclosed herein, according to some example embodiments. As shown in FIG. 6, resource manager 602 may be coupled to multiple client accounts 614a, 614b, and 614n. In particular implementations, resource manager 602 can support any number of client accounts desiring access to the execution platform 604 and/or or shared database storage 608. Client accounts 614a, 614b, and 614n may include, for example, end users providing user files to be ingested into the database, data storage and retrieval requests, system administrators managing the systems and methods described herein, and other components/devices that interact with resource manager 602.

Resource manager 602 provides various services and functions that support the operation of all systems and components within data processing platform 600. Resource manager 602 may be coupled to shared metadata 612, which is associated with the entirety of data stored throughout data processing platform 600. In some embodiments, shared metadata 612 may include a summary of data stored in remote data storage systems as well as data available from a local cache. Additionally, shared metadata 612 may include information regarding how data is organized. in the remote data storage systems and the local caches. Shared metadata 612 may allow systems and services to determine whether a piece of data needs to be processed without loading or accessing the actual data from a storage device.

Resource manager 602 may be further coupled to the execution platform 604, which provides multiple computing resources that execute various data storage and data retrieval tasks, as discussed in greater detail below. The execution platform 604 includes a plurality of execution nodes 606a, 606b, 606c, and 606n configured to process various tasks associated. with the database, including ingesting new user files and. generating one or more micro-partitions for a table of a database based on the new user files. Execution platform 604 may be coupled. to shared. database storage 608 including multiple data storage devices 610a, 610b, 610c, and 610n. In some embodiments, the shared database storage 608 includes cloud-based storage devices located in one or more geographic locations. For example, the shared database storage 608 may be part of a public cloud infrastructure or a private cloud infrastructure. The shared database storage 608 may include hard disk drives (HDDs), solid state drives (SSDs), storage clusters or any other data storage technology. Additionally, shared database storage 308 may include distributed file systems (such as Hadoop Distributed File Systems (HDFS)), object storage systems, and the like. It should be appreciated that the shared database storage 608 may be accessible by one or more instances of the resource manager 602 but may not be accessible by all client accounts 614a-614n. In an embodiment, a single instance of the resource manager 602 is shared by a plurality of client accounts 614a-614n. In an embodiment, each client account 614a-614n has its own resource manager and/or its own shared database storage 608 that is shared amongst a plurality of execution nodes 606a-606n of the execution platform 304. In an embodiment, the resource manager 602 is responsible for providing a particular client account 614a-314n access to particular data within the shared database storage 608.

In particular embodiments, the communication links between resource manager 602 and client accounts 614a-614n, shared metadata 612, and execution platform 604 are implemented via one or more data communication networks. Similarly, the communication links between execution platform 604 and shared database storage 608 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

As shown in FIG. 6, data storage devices 610a-610n are decoupled from the computing resources associated with execution platform 604. This architecture supports dynamic changes to data processing platform 600 based on the changing data storage/retrieval needs as well as the changing needs of the users and systems accessing data processing platform 600. The support of dynamic changes allows data processing platform 600 to scale quickly in response to changing demands on the systems and. components within data processing platform 600. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

Resource manager 602, shared metadata 612, execution platform 304, and shared database storage 608 are shown in FIG. 6 as individual components. However, each of resource manager 602, shared metadata 612, execution platform 604, and shared database storage 608 may be implemented as a distributed system (e.g., distributed across multiple systems/platforms at multiple geographic locations). Additionally, each of resource manager 602, shared. metadata 612, execution platform 604, and shared database storage 608 can be scaled up or down (independently of one another) depending on changes to the requests received from client accounts 614a-614n and the changing needs of data processing platform 600. Thus, data processing platform 600 is dynamic and supports regular changes to meet the current data processing needs.

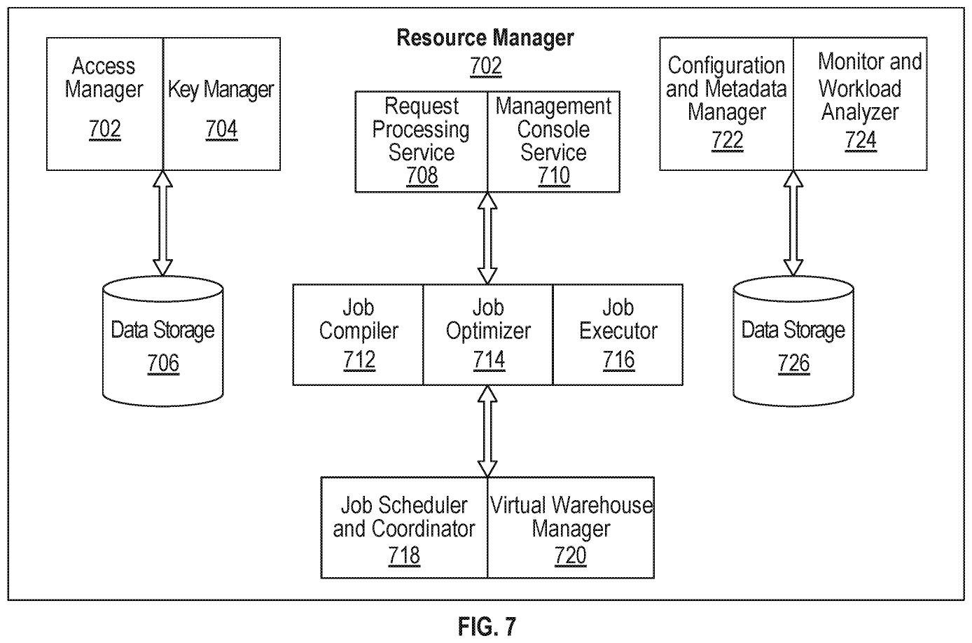

FIG. 7 is a block diagram depicting an embodiment of resource manager 602, according to some example embodiments. As shown in FIG. 7, resource manager 602 includes an access manager 702 and a key manager 704 coupled to a data storage device 706. Access manager 702 may handle authentication and authorization tasks for the systems described herein. Key manager 474 may manage storage and authentication of keys used during authentication and authorization. tasks. A request processing service 708 manages received data storage requests and data retrieval requests. A management console service 710 supports access to various systems and processes by administrators and other system managers.

Resource manager 602 may also include a job compiler 712, a job optimizer 714 and a job executor 716. Job compiler 712 parses tasks, such as ingest tasks, and generates the execution code for the ingestion of user files. Job optimizer 714 determines the best method to execute ingest tasks based on the data that needs to be processed and/or ingested. Job executor 716 executes code for ingest tasks received by resource manager 602. A job scheduler and coordinator 718 may send received user files to the appropriate services or systems for compilation, optimization, and dispatch to the execution platform 304. A virtual warehouse manager 720 manages the operation of multiple virtual warehouses implemented in an execution platform.

Additionally, resource manager 602 includes a configuration and metadata manager 722, which manages the information related to the data stored in the remote data storage devices and in the local caches. A monitor and workload analyzer 724 oversees the processes performed by resource manager 602 and manages the distribution of tasks (e.g., workload) across the virtual warehouses and execution nodes in the execution platform. Configuration and metadata manager 722 and monitor and workload analyzer 724 are coupled to a data storage device 726.

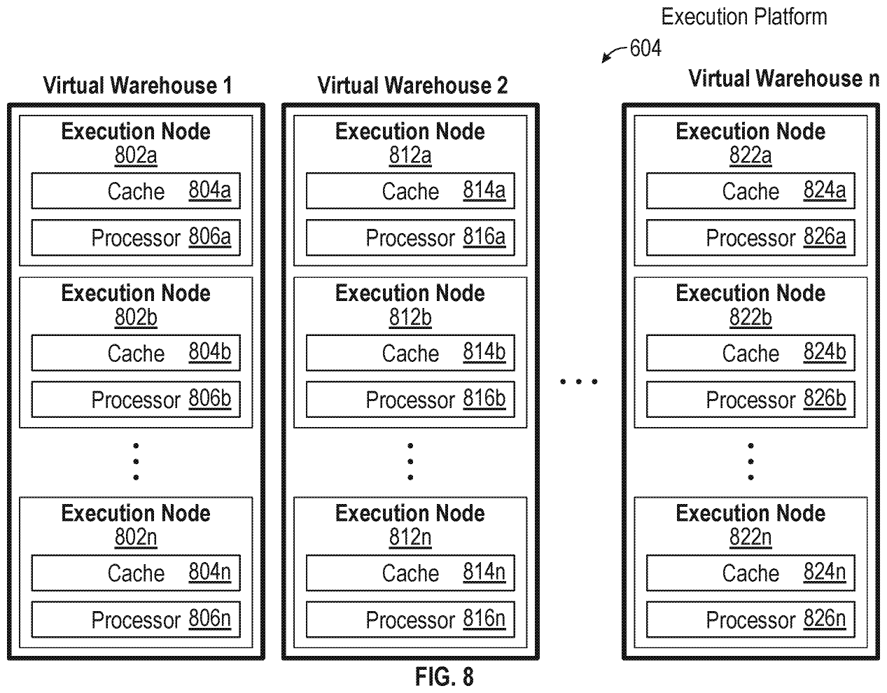

FIG. 8 is a block diagram depicting an embodiment of an execution platform 604, according to some example embodiments. As shown in FIG. 8, execution platform 604 includes multiple virtual warehouses, including virtual warehouse 1, virtual warehouse 2, and virtual warehouse n. Each virtual warehouse includes multiple execution nodes that each include a data cache and a processor. The virtual warehouses can execute multiple tasks in parallel by using the multiple execution nodes. As discussed herein, execution platform 604 can add new virtual warehouses and drop existing virtual warehouses in real-time based on the current processing needs of the systems and users. This flexibility allows the execution platform 604 to quickly deploy large amounts of computing resources when needed without being forced to continue paying for those computing resources when they are no longer needed. All virtual warehouses can access data from any data storage device (e.g., any storage device in shared database storage 308). Although each virtual warehouse shown in FIG. 8 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 610a-610n shown in FIG. 6. Thus, the virtual warehouses are not necessarily assigned to a specific data storage device and, instead, can access data from any of the data storage devices 610a-610n within the shared database storage 608. Similarly, each of the execution nodes shown in FIG. 8 can access data from any of the data storage devices 610a-610n. In some embodiments, a particular virtual warehouse or a particular execution node may be temporarily assigned to a specific data storage device, but the virtual warehouse or execution. node may later access data from any other data storage device.

In the example of FIG. 8, virtual warehouse 1 includes three execution nodes 802a, 802b, and 802n. Execution node 802a includes a cache 804a and a processor 806a. Execution node 802b includes a cache 804b and a processor 806b. Execution node 802n includes a cache 804n and a processor 806n. Each execution node 802a, 802b, and 802n is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual. warehouse 2 includes three execution nodes 812a, 812b, and 812n. Execution node 812a includes a cache 814a and a processor 816a. Execution node 812b includes a cache 814b and a processor 816b. Execution node 812n includes a cache 814n and a processor 816n. Additionally, virtual warehouse 3 includes three execution nodes 822a, 822b, and 822n. Execution node 822a includes a cache 824a and a processor 826a. Execution node 822b includes a cache 824b and a processor 826b. Execution node 822n includes a cache 824n and a processor 826n.

In sonic embodiments, the execution nodes shown in FIG. 8 are stateless with respect to the data the execution nodes are caching For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 8 each include one data cache and one processor, alternate embodiments may include execution nodes containing any number of processors and any number of caches. Additionally, the caches may vary in size among the different execution nodes. The caches shown in FIG. 8 store, in the local execution node, data that was retrieved from one or more data storage devices in the shared database storage 608. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes which is significantly faster and avoids the bottleneck problem discussed above. In some embodiments, the caches are implemented using highspeed memory devices that provide fast access to the cached data. Each cache can store data from any of the storage devices in the shared database storage 308.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned. more cache resources if the tasks performed by the execution node require a larger cache capacity.

Although virtual warehouses 1, 2, and n are associated with the same execution platform 604, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 8 as having multiple execution nodes. The multiple execution nodes associated with each virtual warehouse may be implemented using multiple computing systems at multiple geographic locations. For example, an instance of virtual warehouse 1 implements execution nodes 602a and 602b on one computing platform at a geographic location and implements execution node 602n at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 604 is also fault tolerant. For example, if one virtual warehouse fails, that virtual warehouse is quickly replaced with a different virtual warehouse at a different geographic location.

A particular execution platform 604 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the shared database storage 308 but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

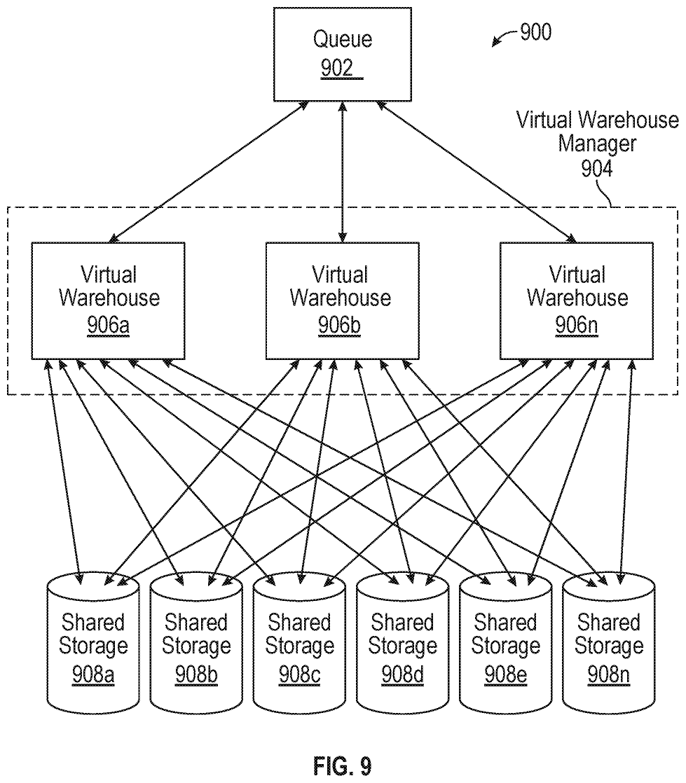

FIG. 9 is a block diagram depicting an example operating environment 900 with the queue 902 in communication with multiple virtual warehouses under a virtual warehouse manager 904. In environment 900, the queue 902 has access to multiple database shared storage devices 908a, 908b, 908c, 908d, 908e, and 908n through multiple virtual warehouses 906a, 906b, and 906n. Although not shown in FIG. 9, the queue 902 may access virtual warehouses through the resource manager 602. In particular embodiments, databases 908a-608n are contained in the shared database storage 608 and are accessible by any virtual warehouse implemented in the execution platform. In some embodiments, the queue 902 may access one of the virtual warehouses 906a-906n using a data communication network such as the Internet. In some implementations, a client account may specify that the queue 902 (configured for storing internal jobs to be completed) should interact with a particular virtual warehouse 906a-906n at a particular time.

In an embodiment (as illustrated), each virtual warehouse 606a-606n can communicate with all databases 908a-908n. In some embodiments, each virtual warehouse 906a-906n is configured to communicate with a subset of all databases 908a-908n. In such an arrangement, an individual client account associated with a set of data may send all data retrieval and data storage requests through a single virtual warehouse and/or to a certain subset of the databases 908a-908n. Further, where a certain virtual warehouse 906a-906n is configured to communicate with a specific subset of databases 908a-908n, the configuration is dynamic. For example, virtual warehouse 906a may be configured to communicate with a first subset of databases 908a-908n and may later be reconfigured to communicate with a second subset of databases 908a-908n.

In an embodiment, the queue 902 sends data retrieval, data storage, and data processing requests to the virtual warehouse manager 904, which routes the requests to an appropriate virtual warehouse 906a-906n. In some implementations, the virtual warehouse manager 904 provides a dynamic assignment of jobs to the virtual warehouses 606a-606n.

In some embodiments, fault tolerance systems create a new virtual warehouse in response to a failure of a virtual warehouse. The new virtual warehouse may be in the same virtual warehouse group or may be created in a different virtual warehouse group at a different geographic location.

The systems and methods described herein allow data to be stored and accessed as a service that is separate from computing (or processing) resources. Even if no computing resources have been allocated from the execution platform, data is available to a virtual warehouse without requiring reloading of the data from a remote data source. Thus, data is available independently of the allocation of computing resources associated with the data. The described systems and methods are useful with any type of data. In particular embodiments, data is stored in a structured, optimized format. The decoupling of the data storage/access service from the computing services also simplifies the sharing of data among different users and groups. As discussed herein, each virtual warehouse can access any data to which it has access permissions, even at the same time as other virtual warehouses are accessing the same data. This architecture supports running queries without any actual data stored in the local cache. The systems and methods described herein are capable of transparent dynamic data movement, which moves data from a remote storage device to a local cache, as needed, in a manner that is transparent to the user of the system. Further, this architecture supports data sharing without prior data movement since any virtual warehouse can access any data due to the decoupling of the data storage service from the computing service.

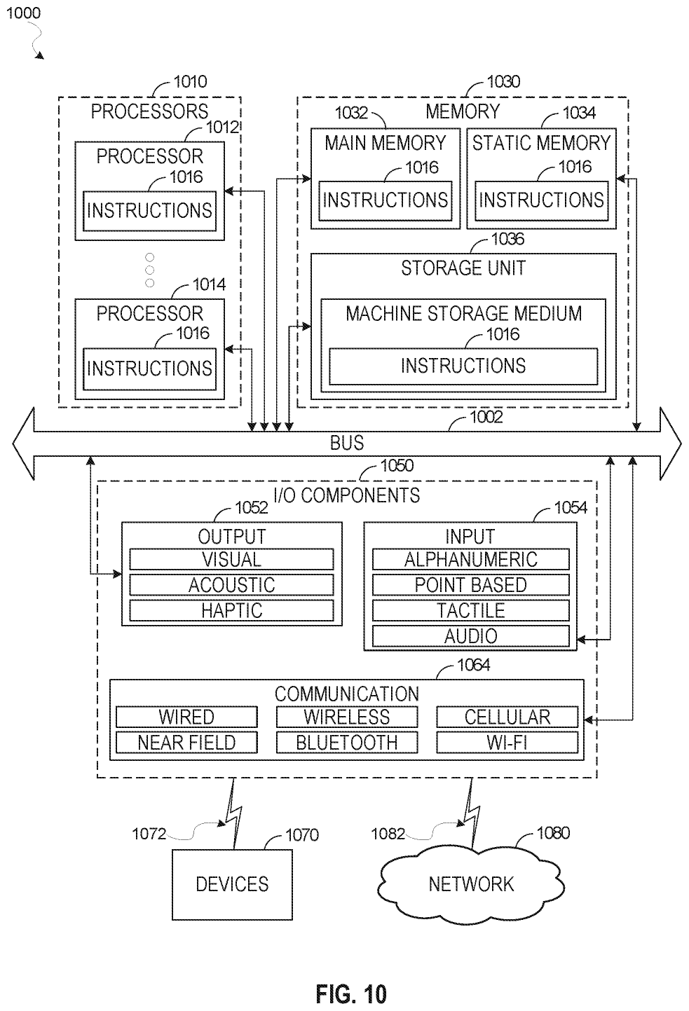

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 916 may cause the machine 1000 to execute any one or more operations of any one or more of the methods or processes described herein. As another example, the instructions 1016 may cause the machine 1000 to implemented portions of the data flows illustrated in any one or more of FIGS. 1-9. In this way, the instructions 1016 transform a general, non-programmed machine into a particular machine 1000 that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 includes processors 1010, memory 1030, and input/output (I/O) components 1050 configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions 1016 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 950 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, and other communication components to provide communication via other modalities. The devices 1070 may be another machine or any of a wide variety of peripheral devices (e.g., a peripheral device coupled via a universal serial bus (USB)). For example, as noted above, the machine 1000 may correspond to any one of the systems and devices described herein.

The various memories (e.g., 1030, 1032, 1034, and/or memory of the processor(s) 1010 and/or the storage unit 1036) may store one or more sets of instructions 1016 and data structures (e.g., software) embodying or utilized by any one or more of the methodologies or functions described herein. These instructions 1016, when executed by the processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized. or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described. with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended. claims, along with the full range of equivalents to which such claims are entitled.

Such embodiments of the inventive subject matter may be referred to herein, individually and/or collectively, by the term “invention” merely for convenience and. without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

in this document, the terms “a” or “an” are used, as is common in patent documents, to include one or more than one, independent of any other instances or usages of “at least one” or “one or more.” In this document, the ⁻term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

The following numbered examples are embodiments:

Example 1. A method comprising: receiving, by one or more processors of a deployment associated with a first cloud provider type, a notification that a queue has new data; detecting a cloud provider type associated with the queue, the detected cloud provider type being different from the first cloud provider type; based on the detected. cloud provider type associated with the queue, routing the notification to a receiver corresponding to the detected cloud provider type; performing, by the receiver, batch data ingestion of the new data; and saving the new data in a target table.

Example 2. The method of example 1, further comprising: retrieving credentials associated with the detected cloud provider type from a pool of credentials; and using the retrieved credentials to perform the batch data ingestion.

Example 3. The method of any of examples 1-2, further comprising: registering metadata concerning the target table in a metadata store after the new data has been saved in the target table, wherein the metadata store stores channel type information of different queues based on cloud provider types.

Example 4. The method of any of examples 1-3, further comprising: receiving a second notification that a second queue has new data; detecting a cloud provider type associated with the second queue, the cloud provider type of the second queue being different from the cloud provider type of the queue; based on the detected cloud provider type associated with the second queue, routing the second notification to a second receiver corresponding to the detected cloud provider type of the second queue; performing, by the second receiver, batch data ingestion of new data in the second queue; and saving new data from the second queue in the target table.

Example 5. The method of any of examples 1-4, further comprising: polling a notification channel associated. with the queue, wherein the notification includes information about an occurrence of an event and identification information of a resource associated with the event.

Example 6. The method of any of examples 1-5, wherein the queue comprises a subscription name of a resource.

Example 7. The method of any of examples 1-6, further comprising: assigning the batch data ingestion to an execution node of an execution platform, wherein the execution platform comprises a plurality of execution nodes operating independent of a plurality of shared storage devices.

Example 8. The method of any of examples 1-7, further comprising: generating an ingest history, wherein the ingest history includes one or more of a file name, a table identification, or a file size; and storing the ingest history in a metadata store.

Example 9. The method of any of examples 1-8, further comprising: manage batch data ingestion requests for the target table using consistent hashing, wherein a hash of the consistent hashing is associated with table identification of the target table.

Example 10. A system comprising: one or more processors of a machine; and a memory storing instructions that, when executed by the one or more processors, cause the machine to perform operations implementing any one of example methods 1 to 9.

Example 11. A machine-readable storage device embodying instructions that, when executed by a machine, cause the machine to perform operations implementing any one of example methods 1 to 9.

1. A method comprising:
providing an integration module coupled to a first queue;
receiving, by one or more processors of a deployment associated with a host cloud provider type, a first notification via the integration module that the first queue has first new data, the first notification providing identification information of a resource associated with an event related to the first new data, the receiving comprising polling the first queue to determine whether any new files have been committed to the first queue since a last time the first file queue was polled;
detecting a first cloud provider type associated with the first queue, the detected first cloud provider type being different from the host cloud provider type and the detected first cloud provider type defining a location of the first queue;
based on the detected first cloud provider type associated with the first queue, routing the first notification to one or more first pipes and a first receiver corresponding to the detected cloud provider type, the one or more first pipes storing information relating to the new data and location of the new data;
performing, by the first receiver, batch data ingestion of the first new data, the first receiver being configured for the detected first cloud provider type, the first receiver including an execution platform comprising a plurality of execution nodes, a plurality of shared storage devices collectively storing database data of a target table;
saving the first new data in the target table;
in response to saving the first new data in the target table, registering metadata concerning the target table in a metadata store, the metadata including channel type information of different queues based on cloud provider types;
receiving a second notification that a second queue has second new data;
detecting a second cloud provider type associated with the second queue, the second cloud provider type of the second queue being different from the host and first cloud provider type;
based on the detected second cloud provider type associated with the second queue, routing the second notification to a second receiver corresponding to the detected second cloud provider type of the second queue, the second receiver being different from the first receiver;
performing, by the second receiver, batch data ingestion of new data in the second queue, the second receiver being configured for the detected second cloud provider type; and
saving the second new data from the second queue in the target table.

2. The method of claim 1, further comprising:
retrieving credentials associated with the detected cloud provider type from a pool of credentials; and
using the retrieved credentials to perform the batch data ingestion.

3. The method of claim 1, further comprising:
wherein the metadata store stores classification of the integration module, the one or more pipes, and the receiver based on the cloud provider type.

4. (canceled)

5. The method of claim 1, further comprising:
polling a notification channel associated with the queue, wherein the notification includes information about an occurrence of an event and identification information of a resource associated with the event.

6. The method of claim 1, wherein the queue comprises a subscription name of a resource.

7. The method of claim 1, further comprising:
assigning the batch data ingestion to an execution node of an execution platform, wherein the execution platform comprises a plurality of execution nodes operating independent of a plurality of shared storage devices.

8. The method of claim 1, further comprising:
generating an ingest history, wherein the ingest history includes one or more of a file name, a table identification, or a file size; and
storing the ingest history in a metadata store.

9. The method of claim 1, further comprising:
manage batch data ingestion requests for the target table using consistent hashing, wherein a hash of the consistent hashing is associated with table identification of the target table.

10. A system comprising:
one or more processors of a machine; and
a memory storing instructions that, when executed by the one or more processors, cause the machine to perform operations comprising:
providing an integration module coupled to a first queue;
receiving, by one or more processors of a deployment associated with a host cloud provider type, a first notification via the integration module that the first queue has first new data, the first notification providing identification information of a resource associated with an event related to the first new data, the receiving comprising polling the first queue to determine whether any new files have been committed to the first queue since a last time the first file queue was polled;
detecting a first cloud provider type associated with the first queue, the detected first cloud provider type being different from the host cloud provider type and the detected first cloud provider type defining a location of the first queue;
based on the detected first cloud provider type associated with the first queue, routing the first notification to one or more first pipes and a first receiver corresponding to the detected cloud provider type, the one or more first pipes storing information relating to the new data and location of the new data;
performing, by the first receiver, batch data ingestion of the first new data, the first receiver being configured for the detected first cloud provider type, the first receiver including an execution platform comprising a plurality of execution nodes, a plurality of shared storage devices collectively storing database data of a target table;
saving the first new data in the target table;
in response to saving the first new data in the target table, registering metadata concerning the target table in a metadata store, the metadata including channel type information of different queues based on cloud provider types;
receiving a second notification that a second queue has second new data;
detecting a second cloud provider type associated with the second queue, the second cloud provider type of the second queue being different from the host and first cloud provider type;
based on the detected second cloud provider type associated with the second queue, routing the second notification to a second receiver corresponding to the detected second cloud provider type of the second queue, the second receiver being different from the first receiver;
performing, by the second receiver, batch data ingestion of new data in the second queue, the second receiver being configured for the detected second cloud provider type; and
saving the second new data from the second queue in the target table.

11. The system of claim 10, the operations further comprising:
retrieving credentials associated with the detected cloud provider type from a pool of credentials; and
using the retrieved credentials to perform the batch data ingestion.

12. The system of claim 10, the operations further comprising:
wherein the metadata store stores classification of the integration module, the one or more pipes, and the receiver based on the cloud provider type.

13. (canceled)

14. The system of claim 10, the operations further comprising:
polling a notification channel associated with the queue, wherein the notification includes information about an occurrence of an event and identification information of a resource associated with the event.

15. The system of claim 10, wherein the queue comprises a subscription name of a resource.

16. The system of claim 10, the operations further comprising:
assigning the batch data ingestion to an execution node of an execution platform, wherein the execution platform comprises a plurality of execution nodes operating independent of a plurality of shared storage devices.

17. The system of claim 10, the operations further comprising:
generating an ingest history, wherein the ingest history includes one or more of a file name, a table identification, or a file size; and
storing the ingest history in a metadata store.

18. The system of claim 10, the operations further comprising:
manage batch data ingestion requests for the target table using consistent hashing, wherein a hash of the consistent hashing is associated with table identification of the target table.

19. A non-transitory machine-storage medium embodying instructions that, when executed by a machine, cause the machine to perform operations comprising:
providing an integration module coupled to a first queue;
receiving, by one or more processors of a deployment associated with a host cloud provider type, a first notification via the integration module that the first queue has first new data, the first notification providing identification information of a resource associated with an event related to the first new data, the receiving comprising polling the first queue to determine whether any new files have been committed to the first queue since a last time the first file queue was polled;
detecting a first cloud provider type associated with the first queue, the detected first cloud provider type being different from the host cloud provider type and the detected first cloud provider type defining a location of the first queue;
based on the detected first cloud provider type associated with the first queue, routing the first notification to one or more first pipes and a first receiver corresponding to the detected cloud provider type, the one or more first pipes storing information relating to the new data and location of the new data;
performing, by the first receiver, batch data ingestion of the first new data, the first receiver being configured for the detected first cloud provider type, the first receiver including an execution platform comprising a plurality of execution nodes, a plurality of shared storage devices collectively storing database data of a target table;
saving the first new data in the target table;
in response to saving the first new data in the target table, registering metadata concerning the target table in a metadata store, the metadata including channel type information of different queues based on cloud provider types;
receiving a second notification that a second queue has second new data;
detecting a second cloud provider type associated with the second queue, the second cloud provider type of the second queue being different from the host and first cloud provider type;
based on the detected second cloud provider type associated with the second queue, routing the second notification to a second receiver corresponding to the detected second cloud provider type of the second queue, the second receiver being different from the first receiver;
performing, by the second receiver, batch data ingestion of new data in the second queue, the second receiver being configured for the detected second cloud provider type; and
saving the second new data from the second queue in the target table..

20. The non-transitory machine-storage medium of claim 19, further comprising:
retrieving credentials associated with the detected cloud provider type from a pool of credentials; and
using the retrieved credentials to perform the batch data ingestion.

21. The non-transitory machine-storage medium of claim 19, further comprising:
wherein the metadata store stores classification of the integration module, the one or more pipes, and the receiver based on the cloud provider type.

22. (canceled)

23. The non-transitory machine-storage medium of claim 19, further comprising:
polling a notification channel associated with the queue, wherein the notification includes information about an occurrence of an event and identification information of a resource associated with the event.

24. The non-transitory machine-storage medium of claim 19, wherein the queue comprises a subscription name of a resource.

25. The non-transitory machine-storage medium of claim 19, further comprising:
assigning the batch data ingestion to an execution node of an execution platform, wherein the execution platform comprises a plurality of execution nodes operating independent of a plurality of shared storage devices.

26. The non-transitory machine-storage medium of claim 19, further comprising:
generating an ingest history, wherein the ingest history includes one or more of a file name, a table identification, or a file size; and
storing the ingest history in a metadata store.

27. The non-transitory machine-storage medium of claim 19, further comprising:
manage batch data ingestion requests for the target table using consistent hashing, wherein a hash of the consistent hashing is associated with table identification of the target table.
